(19) United States
(12) Patent Application Publication
(10) Pub. No.: US 2021/0342897 A1
(43) Pub. Date: Nov. 4, 2021

(54) SYSTEMS AND METHODS FOR OPERATING A DISPLAY BOARD

(71) Applicant: Surfaces Southeast, LLC, Doral, FL (US)

(72) Inventors: Albert Claramonte, Miami Beach, FL (US); Nauro de Rezende, JR., Suwanee, GA (US)

(21) Appl. No.: 17/227,651

(22) Filed: Apr. 12, 2021

Related U.S. Application Data
(60) Provisional application No. 63/017,829, filed on Apr. 30, 2020.
(60) Provisional application No. 63/051,044, filed on Jul. 13, 2020.

(51) Int. Cl. G06Q 30/02; G06F 3/147; G06F 3/048; G06K 7/14; G06K 7/10; G06N 5/04; G09F 9/30; G09F 3/00

(52) U.S. Cl. CPC G06Q 30/0281; G06F 3/147; G06F 3/048; G06Q 30/0201; G06Q 30/0267; G06Q 10/087; G06K 7/10297; G06N 5/04; G09F 9/30; G09F 3/0298; G06K 2007/10504; G06K 7/1413

(57) ABSTRACT

Systems and methods for operating a digital display board are provided. The display board may be placed in a retailer, such as a home improvement store, a tile store, or a hardware store, at or near a location where tile is displayed for purchase. The display board may be thought of as a virtual tile board and may be programmed to display information about the tile that is available at the associated retailer. The tile that is featured on the display board may be based on real-time inventory information provided by the tile manufacturer or retailer, as well as based on any promotions being offered by the manufacturer or retailer. In addition, the retailer may provide retailer-specific branding or other information that may be displayed along with the tile information.

### CROSS-REFERENCE TO RELATED APPLICATIONS

This application claims priority to U.S. Provisional Patent Application Ser. No. 63/017,829, entitled “SYSTEMS AND METHODS FOR OPERATING A DISPLAY BOARD”, and filed on Apr. 30, 2020. This application further claims priority to U.S. Provisional Patent Application Ser. No. 63/051,044, entitled “ARTIFICIAL INTELLIGENCE AND MACHINE LEARNING USES FOR RETILE”, and filed on Jul. 13, 2020. The contents of both are hereby incorporated by reference in their entirety.

### BACKGROUND

Retail displays, such as tile boards, are important tools for selling products in a retail environment. With respect to tile boards, these boards typically include a selection of tiles that are available from a manufacturer or distributor along with information about each tile such as type of material, size, and available colors. These boards are provided by tile manufacturers or distributors to retailers where they may be displayed to customers.

While tile boards are an effective way of advertising products to customers, there are drawbacks associated with tile boards. First, tile boards are expensive to manufacture and ship to retailers. Tile manufactures often have multiple tile collections, each with multiple options and configurations which may require that multiple tile boards be created and shipped to each retailer location. Second, tile boards cannot routinely show all of the tile collections and options within those collections that are available from a manufacturer or distributor. Third, tile boards are by their nature static, and cannot be easily updated to account for changes in the availability of certain tiles, or to reflect promotions provided by the retailer or tile manufacturer.

### SUMMARY

Systems and methods for operating a digital display board are provided. The display board may be placed in a retailer, such as a home improvement store, a tile store, or a hardware store, at or near a location where tile is displayed for purchase. The display board may be thought of as a virtual tile board and may be programmed to display information about the tile that is available at the associated retailer. The tile that is featured on the display board may be based on real-time inventory information provided by the tile manufacturer or retailer, as well as based on any promotions being offered by the manufacturer or retailer. In addition, the retailer may provide retailer-specific branding or other information that may be displayed along with the tile information. Consumers at the retailer may interact with the display board, directly or indirectly through a mobile device, to view additional information about a particular tile sample, to see examples of the tile in example rooms, and to see the tile along with selected paint and/or grout colors. Consumers may be linked to user profiles through their mobile devices, and information about the particular tile samples that each consumer interacts with may be captured and used for purposes of marketing to the customers as well as product research. As an additional feature, the display board may detect, using RFID, computer vision, or barcodes, what physical tile a customer is interacting with, and may display information corresponding to the physical tile on the digital display board.

The digital display board may further include an artificial intelligence engine that collects product sales data and customer data to enable various features. These features may include identifying optimal areas of the display board to derive sales, determining dynamic prices and dynamic promotions for products and customers, identifying new or missing products, and identifying problem areas or departments of retail locations. Other features will be discussed further below.

In an embodiment, a method for operating a display board is provided. The method includes: receiving product data for a retailer by a computing device, wherein the product data identifies a plurality of products available at the retailer; receiving preference data for the retailer by the computing device; based on the product data and preference data, displaying a graphical user interface on a display board located at the retailer by the computing device, wherein the graphical user interface displays a representation for each of the identified plurality of products according to the preference data; receiving an indication of an interaction with one of the representations by a customer by the computing device; and in response to the received interaction, displaying information about the product associated with the representation that was interacted with by the customer on the display board by the computing device.

Embodiments may include some or all of the following features. The plurality of products may include tiles. The method may further include storing the indication of the interaction. The method may further include determining a user profile associated with the customer and associating the interaction with the user profile. The method may further include providing an incentive to the customer. The method may further include determining a mobile device associated with the customer and providing the information about the product to the mobile device associated with the customer. The method may further include detecting a physical product being interacted with by the customer; and in response to the detection, displaying information about the physical product on the display board. Detecting a physical product may include one or more of detecting a barcode on the physical product, detecting a RFID associated with the physical product, and detecting the physical product using a camera associated with the display board.

In an embodiment, a system for operating a display board is provided. The system includes: a display board, and at least one computing device. The at least one computing device is adapted to: receive product data for a retailer, wherein the product data identifies a plurality of products available at the retailer; receive preference data for the retailer; based on the product data and preference data, display a graphical user interface on the display board located at the retailer, wherein the graphical user interface displays a representation for each of the identified plurality of products according to the preference data; receive an indication of an interaction with one of the representations by a customer; and in response to the received interaction, display information about the product associated with the representation that was interacted with by the customer on the display board.

Embodiments may include some or all of the following features. The plurality of products may include includes tiles. The at least one computing device may be further adapted to store the indication of the interaction. The at least one computing device may be further adapted to determine a user profile associated with the customer and associate the interaction with the user profile. The at least one computing device may be further adapted to provide an incentive to the customer. The at least one computing device may be further adapted to: determine a mobile device associated with the customer; and provide the information about the product to the mobile device associated with the customer. The at least one computing device may be further adapted to: detect a physical product being interacted with by the customer; and in response to the detection, display information about the physical product on the display board. Detecting a physical product may include one or more of detecting a barcode on the physical product, detecting a RFID associated with the physical product, and detecting the physical product using a camera associated with the display board.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for operating a display board;

FIG. 2 is an illustration of an example environment for operating a display board showing additional details;

FIG. 3 is an operational flow of an implementation of a method for operating a display board; and

FIG. 4 shows an exemplary computing environment in which example embodiments and aspects may be implemented.

### DETAILED DESCRIPTION

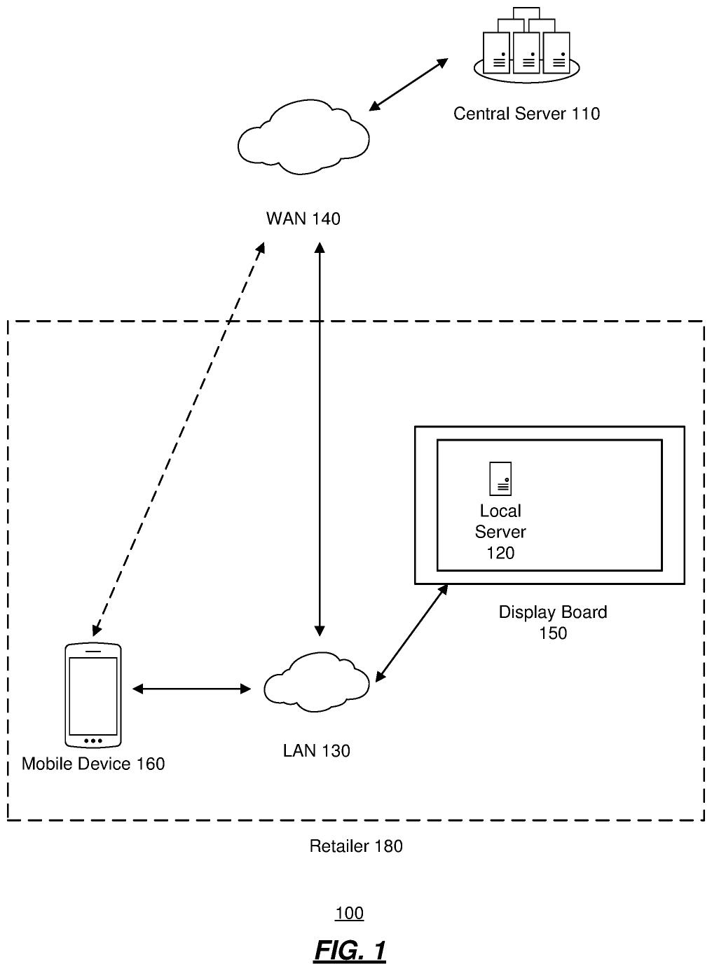

FIG. 1 is an illustration of an exemplary environment 100 for operating a display board 150. The environment 100 includes a local server 120 that controls and/or provides data to a display board 150 through a local area network 130 located at a retailer 180. The retailer 180 may include a variety of stores or retail environments that include, but are not limited to, tile stores, hardware stores, departments stores, furniture stores, and home improvement stores. As shown, the display board 180 may be part of the local server 120. Alternatively, the local server 120 may be separate from the display board 150.

The display board 150 may be a monitor or television that is placed at a location within the retailer 180. The display board 150 may display information about one or more products available at the retailer 180. A user or customer may then interact with the display board 150 to receive additional information about the one or more products. Note that while only one display board 150 is shown at the retailer 180, it is for illustrative purposes only. In some embodiments, each retailer 180 may be associated with multiple display boards 150. The display boards 150 at a retailer 180 may each operate independently from one another or may operate together as an array of display boards 150, for example.

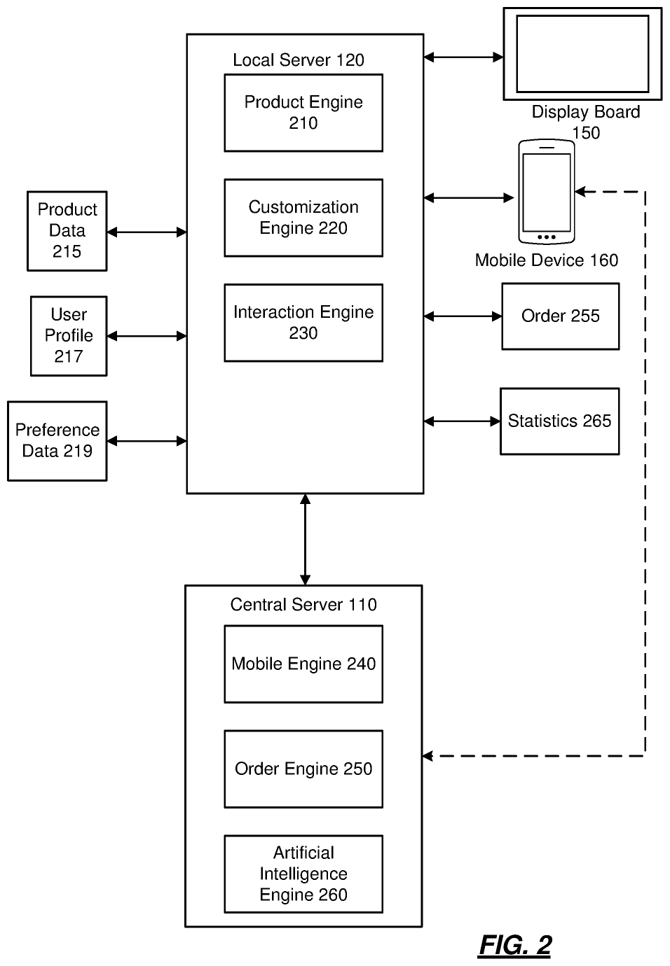

For example, the display board 150 may be positioned at or around a location of the retailer 180 where tile is sold. The display board 150 may display images of the various types of tiles that are sold by the retailer 180. A customer at the retailer 180 may select an image of a displayed tile (e.g., using a touch interface provided by the display board 150). In response, the display board 150 may display additional information about the tile such as cost, colorways, and suitable uses. The display board 150 may further show images of the selected tile in various rooms, may allow the customer to view the tile with different paint and grout selections, etc. The display board 150 may further allow the customer to calculate and/or specify the amount of tile needed for a project and may allow the customer to order the tile directly from the display board 150. Other features may be described with respect to FIG. 2.

The display board 150 may receive data from the local server 120. The data may include information about the products that are sold by the retailer 180 (including real or near-real time inventory data). The display board 150 may further receive preference information for the retailer 180 from the local server 120. The preference information may control how and what products are displayed on the display board 150, and any retailer 180 specific graphics, logos, or branding that should be used by the display board 150.

For example, a retailer 180 such as a home improvement store may be running a promotion on tile. An administrator associated with the retailer 180 may use the central server 110 to have the display board 150 display information about the promotion and to promote particular tiles that are associated with the promotion. The administrator may further provide logos or branding associated with the promotion.

The display board 150 may further interact with one or more mobile devices 160. The mobile devices 160 may include smart phones, laptops, tablet computer, and any other type of computing device that may be associated with a customer. The display board 150 may receive selections or indications of interest in the products displayed on the display board 150 from the customer by a mobile device 160 and may provide information about the particular products to the mobile device 160. The information may be displayed to the customer by the mobile device 160. Depending on the embodiment, the mobile device 160 may connect to the display board 150 through the LAN 130, through the central server 110 using WAN 140, or may connect to the display board 150 directly using Bluetooth™ or another wireless technology.

For example, a customer may approach the display board 150 and may use their mobile device 160 to scan a QR code displayed on the display board 150. Upon scanning the QR code, the mobile device 160 may connect to the display board 150 or may download an app associated with the display board 150. The mobile device 160 may then display some or all of the products (e.g., tiles) displayed on the display board 150, and the customer may then interact with the products similarly as described above for the display board 150.

In some embodiments, the display board 150 may detect a particular physical product (i.e., a product actually located at the retailer 180), and in response to the detection, may display information about the physical product. Depending on the embodiment, the products may have affixed a barcode or RFID tag that is detected by a corresponding sensor or camera associated with the display board 150. Alternatively, the display board 150 may use computer vision techniques to detect and/or recognize the particular physical product being held by the customer. As another example, the display board 150 may know the shelf or bin that the customer selected the physical product from and may determine the physical product using a mapping provided by the retailer 180 that maps the shelves and bins to physical products. Other techniques may be used.

The local server 120 may receive the information about the various products to be displayed by the display board 150 from a central server 110 through a wide-area network 140 (e.g., the Internet). The central server 110 may communicate with multiple retailers 180 and may receive information from the retailers 180 including inventory information about each retailer 180. Each retailer 180 may have their own display board 180 including integrated local server(s) 120. The inventory information may include real-time or near real-time information about the particular products that are stocked by each retailer 180. Each local server 120 may use the inventory information received from the central server 110 to determine what products to display on the display board 150.

The central server 110 may further provide product information about each product to the local servers 120. The product information may include information that may be provided to the customers by the display board 150.

The local server 120 may record the various interactions between customers and the display board 150 and/or the mobile devices 160 and may provide the information to the central server 110 through the wide-area network 140. The central server 110 may receive the interactions from various local servers 120 and may process the interactions to determine information about the products and customers associated with each retailer 180.

For example, the central server 110 may use the information to determine what products are selling better than others, which retailers 180 are most effectively selling the products, and how the various promotions are working. The central server 120 may further identify what products particular customers are interested in through their interactions and may provide customers with additional information about these products. For example, the central server 110 may email the customers with the additional information.

In some embodiments, the local server 120 and/or the central server 110 may connect a customer (either through the display board 150 or mobile device 160) directly to an ordering system associated with the retailer 180. The customer may then place an order for a product directly with the retailer 180. For example, the retailer 180 may expose an application programming interface (API), electronic data interchange (EDI), or other protocols to the local server 120 and/or central server 110 that may be used to facilitate the ordering.

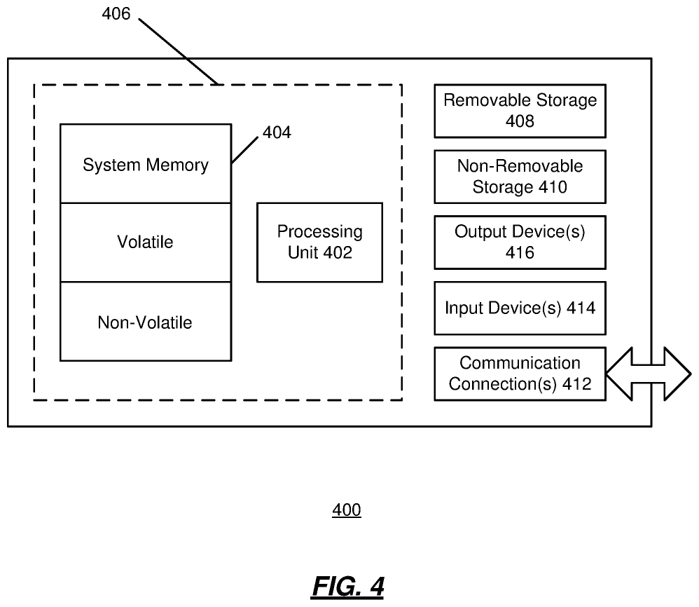

FIG. 2 is an illustration of an example environment for operating a display board showing additional details. As shown, the local server 120 includes several components including, but not limited to, a product engine 210, a customization engine 220, and an interaction engine 230. Further, the central server 110 includes several components including a mobile engine 240, an order engine 250, and an artificial intelligence (“A.I.”) engine 260. Each of the components of the local server 120 and the central server 110 may be implemented together, or separately, by one or more computing systems such as the computing system 400 illustrated with respect to FIG. 4. Note that some or all of the components of the local server 120 may be implemented by the central server 110, and vice versa.

The product engine 210 may receive and store product data 215 from the central server 110. The product data 215 may include information about the products that will be displayed by the display board 150. Where the products are tiles, the product data 215 may include color, name, shape, price, and material, for example. The product data 215 may further include images and/or videos of each tile, as well as images of the tiles installed in various rooms and other locations. The product data 215 may further include reviews of each tile.

In some embodiments, the product data 215 may further include inventory information about the tile. The information may be specific to the particular retailer 180 where the local server 120 is located. The inventory information may be provided by the central server 110 or may be provided directly by the retailer 180.

The customization engine 220 may allow an administrator or user associated with the retailer 180 to customize how the display board 150 displays the products identified in the product data 215. The administrator may provide the customization engine 220 with preference data 219 that includes preferences on how the administrator would like the products to be displayed. The preference data 219 may include information such as the number of products to display at a time on the display board 150, the fonts and colors to use on the display board 150, and the particular graphics or branding to use on the display board. Other information and/or data may be included in the preference data 219.

The interaction engine 230 may facilitate the interaction between one or more customers and the display board 150. In some embodiments, the interaction engine 230 may detect when a customer has selected one of the products displayed on the display board 150. For example, the display board 150 may include a touch interface and may detect that a customer has touched a particular location on the display board 150. The interaction engine 230 may determine the product associated with the location on the display board 150, and may provide (e.g., display) additional information about the selected product. The information about the product may be determined from the product data 215. Besides a touch interface, the customer may interact with the touch screen using a mouse or a voice interface (e.g., “show me more information about tile #2”).

The interaction engine 230 may allow the customer to interact with products in a variety of ways. For example, where the product is a tile, the customer may interact with the tile on the display board 150. The customer may view the tile in a variety of different rooms and settings, view the tile in an image of a room provided by the customer, rotate and inspect a three-dimensional model of the tile, and view the tile with a variety of customer selectable grout colors and paint colors. In some embodiments, the customer may even contact a customer support agent or designer through the interaction engine 230 to discuss the particular tile.

In some embodiments, rather than select a product via a touch interface, the interaction engine 230 may detect that the customer is interacting with a physical product and may display additional information about the product on the display board 150. For example, each product may have a QR code (or other code) affixed to the product. When the customer holds the product, the interaction engine 230 may read the QR code (using a camera associated with the display board 150) and may retrieve and display information about the product using the code. As another example, the interaction engine 230 may receive an image of the product being held by the customer from the display board 150. The interaction engine 230 may use computer vision techniques and a set of known product images to determine which product the customer is holding. The interaction engine 230 may then display information about the determined product on the display board 150.

In some embodiments, the interaction engine 230 may generate and/or store a user profile 217 based on each customer that interacts with the display board 150. When the customer begins interacting with the display board 150, the interaction engine 230 may request contact information for the customer such as an email address or a telephone number. The interaction engine 230 may then create a user profile 217 using the contact information, or if a user profile 217 already exists, the interaction engine 230 may retrieve the user profile 217. Depending on the embodiment, the customer may be offered an incentive (e.g., a coupon or discount) in exchange for providing the contact information.

After the customer has finished interacting with the display board 150, the interaction engine 240 may store statistics 265 about the interaction with the user profile 217. The statistics 265 may include which products the customer interacted with and any other information provided by the customer during the interaction. The statistics 265 may be later used to determine which products are popular with customers, or to market or provide incentives to customers who may not have purchased any products using the display board 150.

In some embodiments, the interaction engine 130 may customize the display board 150 based on the user profile 217. For example, the interaction engine 230 may use the statistics 265 associated with the user profile 217 from previous interactions to recommend products that the customer may be interested in or that the customer viewed previously but did not purchase.

The mobile engine 240 may facilitate the interaction between the display board 150 and a mobile device 160 of the customer. In some embodiments, the customer may use their mobile device 160 to download an app or mobile application associated with the retailer 180. When the mobile device 160 (using a location determination component) determines that the mobile device 160 is near the display board 150, the app may connect the mobile device 160 to the display board 150 via the central server 110. While connected the display board 150 may push information about one or more products to the mobile device 160.

In another embodiment, the mobile engine 240 may cause the display board 150 to display a QR code (or other type of code). A customer may scan the code, which may cause the mobile device 160 to communicate directly with the display board 150 (or indirectly via the mobile engine 240 of the central server 110). While connected, the display board 150 (or the mobile engine 240) may push information about one or more products to the mobile device 160.

When the user interacts with the display board 150, the display board 150 may ask the customer if they would like to continue the interaction on their mobile device 160. If the customer agrees, the interaction between the customer and the display board 150 may shift to the mobile device 160. In this way, the mobile device 160 may function as a mini-display board 150 for the customer, with all functions provided by the display board 150 made available to the customer through their mobile device 160. This has the advantage of freeing the display board 150 for use by another customer. It also allows the display board 150 to serve multiple customers at the same time, even though only a single customer may interact directly (i.e., using the touch interface) with the display board 150 at a given time.

In some embodiments, the customer may control the display board 150 using their mobile device 160. For example, if the customer selects a particular tile on their mobile device 160, information about the selected tile may be displayed to the customer on the display board 150. The mobile engine 240 may facilitate the transfer of information between the display board 150 and the mobile device 160.

The order engine 250 may allow customers to place orders 255 for one or more products directly through the display board 150 (or through their mobile device 160). When a customer views a product such as a tile, the order engine 250 may cause the display board 150 to display the amount of the tile that is available at the retailer 180 as well as the price. If sufficient tile is available, the customer may enter payment information into the display board 150 or through their mobile device 160. The order engine 250 may then complete the payment transaction and may facilitate delivery of the tile to the customer at the retailer 180 (or another location). If the amount of tile is not sufficient, the order engine 250 may generate an order 255 and submit the order 255 to a manufacturer associated with the tile. In some embodiments, the retailer 180 may expose an application programming interface (API), electronic data interchange (EDI), or other protocols to the order engine 250 that may be used to facilitate the ordering.

The A.I. engine 260 may provide a variety of A.I. and machine learning features to the display board 150. As one example A.I. feature, the A.I. engine 260 may provide is product placement.

In one embodiment, the A.I. engine 260 may identify what are referred to herein as the most-valuable positions (“MVP”) on the screens of a display board 150. The MVPs on the display board 150 may be those positions, regions, or areas of the display board 150 that result in the greatest sales with respect to the displayed products. Once identified, these MVP regions may be used to display products that a particular store wishes to sell quickly, or that may not be selling as well as anticipated.

In one embodiment, the A.I. engine 260 may divide the display board into some number of similarly sized areas. The size and number of areas may depend on the resolution and size of the display board 150. Generally, each area may be sized to display information about a single product. For example, for a display board 150 in a tile store each area may be used to display a single tile product, or group of products from a single manufacturer or tile line.

In order to determine the MVPs, the A.I. engine 260 may periodically run one or more experiments. In each experiment, the A.I. engine 260 may adjust the particular products that are displayed in each area of the display board 150 for some period of time. The A.I. engine 260 may then compare the sales of each product or general interest in each product (from the statistics 265) observed by the display board 150 with the sales or interest observed for the same products during different periods when the products were displayed at different areas of the display board 150. The display board 150 may adjust the observed sales or interest to account for sales, holidays, weather, or any other factors that may affect the amount of sales or interest in a particular product. By repeatedly changing the locations of particular products in each area of the display board 150 the A.I. engine 160 may eventually identify those areas whose associated products tend to sell better or receive more interest and attention than other areas. These identified areas are the MVPs of the display board 150.

As may be appreciated, when determining the MVPs, the A.I. engine 260 may consider or control for a variety of factors including the location of the display board 150, the region of the country that the display board 150 is located, the particular layout of the display board 150, the price of each product, the color of each product, the shape of each product, the conversion rate of each product, the relative prices of all of the products displayed on the display board 150, and the dates and/or times that each product was displayed. Depending on the embodiment, the MVPs may be determined for each individual display board 150 or may be determined globally for all display boards 150 using the statistics 165 collected by each display board 150.

As another example A.I. feature, the A.I. engine 260 may identify cross selling or upselling opportunities for retailers 180 that utilize a display board 150. For example, the A.I. engine 260 may analyze the products that are purchased by each customer through the display board 150 to identify products that are typically bought together or bought within some threshold amount of time of each other by the same purchaser or household. Once identified, the A.I. engine 260 may use these identified products for cross-selling or upselling purchases.

For example, when a customer is purchasing a particular tile through the display board 150, the display board 150 may recommend a particular toilet or towel set that is often purchased along with the particular tile. The customer may then choose to purchase the recommended items through the display board 150.

In addition, the A.I. engine 260 may further consider the purchase history of each customer, their associated user profile 217, and the display board 150 navigation history of each customer (i.e., what products did they look at but not purchase) when determining what products to recommend to the customer through the display board 150. In addition, the A.I. engine 260 may recommend products through the mobile device 160.

When determining items or products the A.I. engine 260 may consider some or all of the following information from the statistics 265 including, but not limited to, the initial consumer interaction point (e.g., did the customer first use the display board 150, website, mobile device 160, or other means to purchase or browse products), first product selected, interaction patterns (e.g., what other products has the customer looked at), region of the store (e.g., where in the store is the display board 150 located in), the store location (e.g., what part of the country is the store located at), type of device used to interact with the system (e.g., did the customer use the display board 150, the mobile device 160, or both), the conversions rate of the customer, and the date and time. Other information may be considered by the A.I. engine 260.

The A.I. engine 260 may further use natural language to communicate with customers through the display board 150 and the mobile device 160. The communications may include promoting particular products, and asking a customer if they need help, for example. The A.I. engine 260 may maintain a dictionary of forbidden words and phrases such as curse words or other language that customers may find offensive. This may ensure that the A.I. engine 260 does not generate any offensive, illegal, or inappropriate messages or texts.

The A.I. engine 260 may further randomly or periodically vary the particular words and phrases that are used to interact with customers or recommend products. For example, rather than saying “Based on your order history, we recommend product X” the A.I. engine 260 may have the display board 150 say “Customers like you also purchased X.” At the same time, the A.I. engine 260 may monitor how the particular words and phrases affected conversion rates. In this way the effectiveness of certain words and phrases with respect to product sales may be measured, and optimal words and phrases may be selected. The effectiveness of words and phrases may also be determined across user profiles 217 and geographic regions. As may be appreciated the words and phrases that are effective for certain customer types in certain regions of the country may not be the same for other customer types in other regions of the country.

As another example A.I. feature, the A.I. engine 260 may help retailers identify missing or non-existent products for the retailers to sell. For example, the A.I. engine 260 may determine that products of a particular color are popular. The A.I. engine 260 may determine that a retailer 180 offers few tile products in the popular color and may recommend that the retailer 180 stock or create tiles in the new color.

Similarly, the A.I. engine 260 may recognize that a particular product is popular either online or in another store but is not available at the store where the display board 150 is located. The A.I. engine 260 may recommend that the retailer 180 stock the product and may even offer to order the product automatically from the manufacturer.

Depending on the embodiment, the A.I. engine 260 may consider the following data when recommending or suggesting new products to a retailer 180: overall sales per product (e.g., how much money is the product generating online or in other retail locations), the total number of units of the product sold (e.g., how much of the product is being sold), characteristics of the product (e.g., color, coverage, shape, and price), overall store sales and product interest, and the current date and time. Other factors may be considered.

As another example A.I. feature, the A.I. engine 260 may provide dynamic pricing and dynamic offers. Similarly, as described above with respect to MVPs, the A.I. engine 260 may experiment with pricing by periodically changing the displayed price of items to measure the affect of price on product sales. In this way, the A.I. engine 260 may determine an optimal price for each product based on a desired sales target.

In some embodiments, the A.I. engine 260 may also determine the optimal price for a product that also considers a variety of other data points such as the region of the country that the display board 150 is located in (e.g., some regions of the country may support a higher or lower price than others), the current time or date (e.g., some products may sell better in the spring than in the winter), and current demand (e.g., if a product is selling better than expected the price may be increased temporality). In addition, the A.I. engine 260 may set the price based on the identity of a customer currently using the display board 150. For example, if the user profile 217 shows that the customer is a frequent purchaser, the display board 150 may offer the customer a higher price on a product.

Similarly, the A.I. engine 260 may determine dynamic offers or discounts to offer customers. This may allow the display board 150 to have high displayed prices while simultaneously increasing customer satisfactions based on perceived discounts. In some embodiments, when a customer is viewing a product on the display board 150, the A.I. engine 260 may determine a dynamic discount to over the customer that is based on a variety of factors such as the purchasing history of the customer, inventory information associated with the product, whether or not the product has been flagged or selected for discounts, current sales data associated with the product, and historical sales data associated with the product. Other information may be included.

As another example A.I. feature, the A.I. engine 260 may track the movements of customers in a retain location. As described above, a retail location may include several display boards 150 located throughout the store. Accordingly, the display boards 150 may track the movement of customers throughout the retail location as the move past the various display boards 150 using cameras or other sensors associated with the display boards 150, and the display boards 150 may provide this information to the A.I. engine 260 of the central server 110. For example, the display boards 150 may recognize customers using computer vision and/or signals received from the mobile devices 160 associated with each customer.

Based on the tracking of customers, the A.I. engine 260 may recognize movement patterns that may indicate problems with the retail location 180. For example, the A.I. engine 260 may determine that certain departments of the store are not being visited by customers when compared to similar retail locations. These problems may be indicated to an administrator by the A.I. engine 260.

The A.I. engine 260 may further use computer vision, user profiles, purchase histories, or other techniques to identify frequent or VIP customers. These customers can be offered special discounts, promotions, or other offers as thanks for frequenting the retail location. Depending on the embodiment, the frequent or VIP customers may be identified across multiple retail locations that include display boards 150.

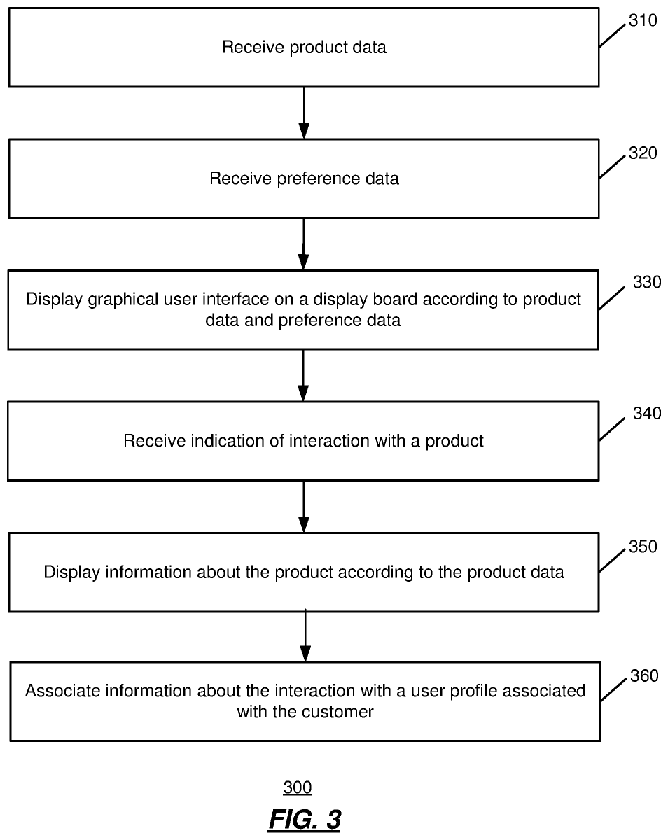

FIG. 3 is an operational flow of an implementation of a method 300 for operating a display board. The method 300 may be implemented separately or together by the local server 120 and/or the central server 110.

At 310, product data is received. The product data 215 may be received by the product engine 210 of the local server 120 from the central server 110. The local server 120 and display board 150 may be at a location associated with a retailer 180. The product data 215 may include information about a variety of products that are sold by the retailer 180 such as tiles. The product data 215 for a tile may include descriptions, size information, images, cost information, reviews, and inventory information (e.g., how many tiles are in the inventory of the retailer 180). The product data 215 may be continuously updated by the central server 110 as new products are created or removed, inventories change, costs change, or new descriptions, images, and/or reviews become available.

At 320, preference data is received. The preference data 219 may be received by the customization engine 220 of the local server 120. The preference data 219 may be provided by an administrator associated with the retailer 180 and may indicate how the retailer 180 desires the products to be displayed on the display board 150. The preference data 219 may identify the particular products that the retailer 180 desires to promote, graphics such as branding that the retailer 180 desires to display, as well as other information such as fonts and colors that the retailer 180 desires for the display board 150. Other information may be included.

At 330, a graphical user interface is displayed on the display board according to the product data and the preference data. The graphical user interface may be rendered and displayed by the interaction engine 230 on the display board 150. Depending on the embodiment, the graphical user interface may have a graphical representation of some or all of the products identified in the product data 215. Where the products are tile, each graphical representation may be an image of the associated tile.

At 340, an indication of an interaction with a product is received. The indication may be received by the interaction engine 230. Depending on the embodiment, the interaction may be from the customer touching a graphical representation with their finger on the display board 150, the customer interacting with the product on their mobile device 160, or the customer speaking the name of the product. Other types of interactions may be supported.

At 350, information about the product is displayed according to the product data. The information may be displayed to the customer on the display board 150 or the mobile device 160 associated with the customer. The information may be associated with the product that the customer interacted with and may include information such the cost of the product, images of the product in various scenarios (e.g., rooms), whether or not the product is in stock at the retailer, etc. The information may be displayed along with a graphical user interface element through which the customer can purchase the product.

At 360, information about the interaction with the product is associated with a user profile corresponding to the customer. The information may be associated by the interaction engine 230 once the customer finishes interacting with the display board 150 and/or the mobile device 160. The information may be associated with the user profile 217 of the customer (if any). The information may be provided by the interaction engine 230 to the central server 110 as the statistics 265. The central server 110 may then use the statistics 265 for marketing or A.I. purposes, for example.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for operating a display board, the method comprising:
receiving product data for a retailer by a computing device, wherein the product data identifies a plurality of products available at the retailer;
receiving preference data for the retailer by the computing device;
based on the product data and preference data, displaying a graphical user interface on a display board located at the retailer by the computing device, wherein the graphical user interface displays a representation for each of the identified plurality of products according to the preference data;
receiving an indication of an interaction with one of the representations by a customer by the computing device; and
in response to the received interaction, displaying information about the product associated with the representation that was interacted with by the customer on the display board by the computing device.

2. The method of claim 1, wherein the plurality of products comprises tiles.

3. The method of claim 1, further comprising:
storing the indication of the interaction.

4. The method of claim 1, further comprising determining a user profile associated with the customer and associating the interaction with the user profile.

5. The method of claim 1, further comprising providing an incentive to the customer.

6. The method of claim 1, further comprising:
determining a mobile device associated with the customer; and
providing the information about the product to the mobile device associated with the customer.

7. The method of claim 1, further comprising:
detecting a physical product being interacted with by the customer; and
in response to the detection, displaying information about the physical product on the display board.

8. The method of claim 7, wherein detecting a physical product comprises one or more of detecting a barcode on the physical product, detecting a RFID associated with the physical product, and detecting the physical product using a camera associated with the display board.

9. A system for operating a display board, the method comprising:
a display board; and
at least one computing device adapted to:
receive product data for a retailer, wherein the product data identifies a plurality of products available at the retailer;
receive preference data for the retailer;
based on the product data and preference data, display a graphical user interface on the display board located at the retailer, wherein the graphical user interface displays a representation for each of the identified plurality of products according to the preference data;
receive an indication of an interaction with one of the representations by a customer; and
in response to the received interaction, display information about the product associated with the representation that was interacted with by the customer on the display board.

10. The system of claim 9, wherein the plurality of products comprises tiles.

11. The system of claim 9, wherein the at least one computing device is further adapted to:
store the indication of the interaction.

12. The system of claim 9, wherein the at least one computing device is further adapted to determine a user profile associated with the customer and associate the interaction with the user profile.

13. The system of claim 9, wherein the at least one computing device is further adapted to provide an incentive to the customer.

14. The system of claim 9, wherein the at least one computing device is further adapted to:
determine a mobile device associated with the customer; and
provide the information about the product to the mobile device associated with the customer.

15. The system of claim 9, wherein the at least one computing device is further adapted to:
detect a physical product being interacted with by the customer; and
in response to the detection, display information about the physical product on the display board.

16. The system of claim 15, wherein detecting a physical product comprises one or more of detecting a barcode on the physical product, detecting a RFID associated with the physical product, and detecting the physical product using a camera associated with the display board.

17. A tangible computer readable medium storing instructions that when executed by a computing device cause the computing device to:
receive product data for a retailer, wherein the product data identifies a plurality of products available at the retailer;
receive preference data for the retailer;
based on the product data and preference data, displaying a graphical user interface on a display board located at the retailer, wherein the graphical user interface displays a representation for each of the identified plurality of products according to the preference data;
receive an indication of an interaction with one of the representations by a customer; and
in response to the received interaction, display information about the product associated with the representation that was interacted with by the customer on the display board.

18. The computer readable medium of claim 17, wherein the plurality of products comprises tiles.

19. The computer readable medium of claim 17, wherein the at least one computing device is further adapted to:
store the indication of the interaction.

20. The computer readable medium of claim 17, wherein the at least one computing device is further adapted to determine a user profile associated with the customer and associating the interaction with the user profile.
